(19) United States
(12) Patent Application Publication
(10) Pub. No.: US 2008/0149583 A1
(43) Pub. Date: Jun. 26, 2008

(54) Collapsible Game Hanger and Storage Device

(76) Inventor: Brian H. Welker, Sugar Land, TX (US)

Correspondence Address: HUSCH BLACKWELL SANDERS LLP, 4801 Main Street, Suite 1000, KANSAS CITY, MO, 64112, US

(21) Appl. No.: 11/613,276

(22) Filed: Dec. 20, 2006

(51) Int. Cl. B66C 23/44

(52) U.S. Cl. 212/180

(57) ABSTRACT

A vehicle-mounted collapsible game hanging assembly is provided that includes a storage receptacle and a game hanging apparatus. The game hanging apparatus has a configuration enabling it be collapsed and stored in the storage receptacle that may be mounted to a vehicle.

### CROSS-REFERENCE TO RELATED APPLICATIONS

None.

### BACKGROUND OF THE INVENTION

Big game hunting is a prevalent outdoor activity in the United States. Once a hunter has taken an animal, the animal's hide must quickly be removed to allow the carcass to cool prior to butchering. The ground in the hunting field most often contains soil, vegetation, and insects that can contaminate an animal's carcass. Thus, it is beneficial to dress the animal while it is suspended in the air. It is also easier to remove an animal's hide while it is suspended in the air as opposed to lying on the ground.

A disadvantage of the known prior art vehicle-mounted game hangers is that none of them are suitable for remaining mounted to a vehicle for transportation. They each need to be removed prior to transportation and then set back up prior to being used. Not only does this delay the removal of the animal's hide, but it is also inconvenient and puts the hunter at risk of losing parts of the game hanger in the hunting field during its set up and take down.

Another disadvantage of the known prior art vehicle-mounted game hangers is that none of them are collapsible such that they are stored in a storage device mounted to a vehicle when they are not in use. Storing a game hanger in a storage device keeps it protected from the weather and elements and keeps it out of sight when not in use.

Accordingly, a need exists for a game hanger that it suitable for remaining mounted to a vehicle for transportation and is configured such that it can be collapsed and stored in a storage device.

### SUMMARY OF THE INVENTION

The present invention is directed to a vehicle-mounted collapsible game hanging assembly that includes a storage receptacle with a base and a lid and a game hanging apparatus with a mast, a boom, and a game suspension assembly. The mast is pivotally coupled to the storage receptacle base. The boom is pivotally coupled to the mast. When the game hanging apparatus is not in use, it can be collapsed and stored within the storage receptacle that is mounted to a vehicle.

The present invention is also directed to a game hanging assembly that includes a means for raising game from the ground, a means for suspending game from the game hanging assembly, a means for attaching the game hanging assembly to a vehicle, and a means for collapsing the game hanging assembly into a configuration enabling it to remain attached to a vehicle for transportation and storage.

### DESCRIPTION OF THE SEVERAL VIEWS OF THE DRAWINGS

FIG. 1 is a front perspective view of the storage receptacle containing a hitch connection member with the lid closed in accordance with one embodiment of the present invention;

FIG. 2 is a front perspective view of the storage receptacle containing mounting brackets with the lid closed in accordance with one embodiment of the present invention;

FIG. 3 is a front perspective view of the storage receptacle containing a hitch connection member with the lid open showing the folded game hanging assembly in accordance with one embodiment of the present invention;

FIG. 4 is a front perspective view of the storage receptacle and one embodiment of the game hanging assembly locked in an unfolded, upright position in accordance with one embodiment of the present invention;

FIG. 5 is a front perspective view of the storage receptacle and one embodiment of the game hanging assembly locked in an unfolded, upright position with a suspended animal carcass in accordance with one embodiment of the present invention;

FIG. 6 is a front perspective view of the storage receptacle and a second embodiment of the game hanging assembly locked in an unfolded, upright position with a suspended animal carcass in accordance with one embodiment of the present invention;

FIG. 7 is a front perspective view of the storage receptacle containing a hitch connection member and one embodiment of the game hanging assembly locked in an unfolded, upright position mounted to an vehicle via its hitch receiver in accordance with one embodiment of the present invention; and

FIG. 8 is a front perspective view of the storage receptacle containing mounting brackets and one embodiment of the game hanging assembly locked in an unfolded, upright position mounted to a vehicle in lieu of its rear bumper in accordance with one embodiment of the present invention.

### DETAILED DESCRIPTION OF THE INVENTION

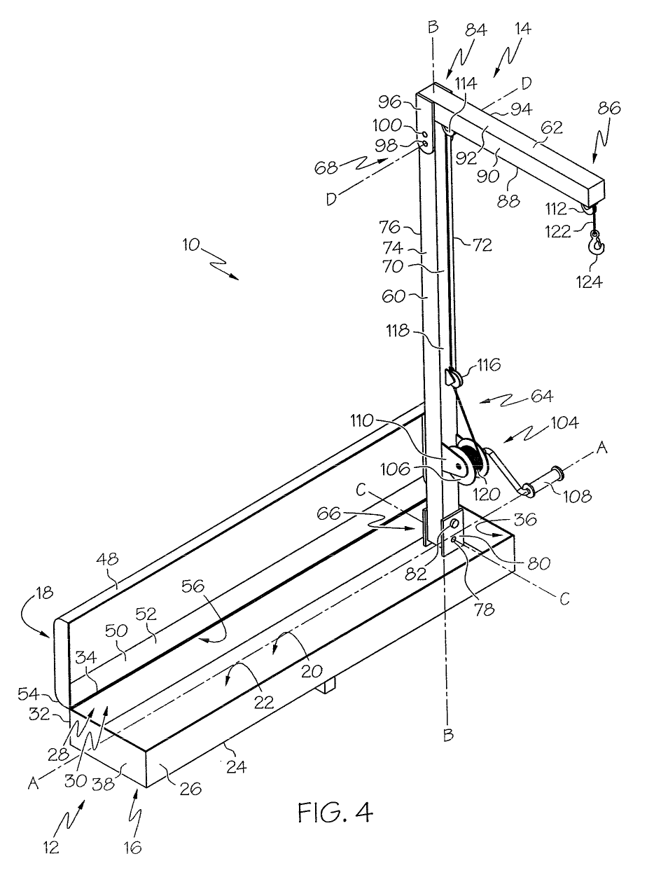

The present invention is directed to a vehicle-mounted collapsible assembly 10 for hanging, cleaning, and/or field dressing wild game such as deer, pigs, antelope, elk, bear, and moose. As shown in FIGS. 4-6, the game hanging assembly 10 includes a storage receptacle 12 and a game hanging apparatus 14. Storage receptacle 12 includes a base 16 and a lid 18. A generally rectangular base 16 includes a bottom wall 20, a front wall 26, a back wall 28, a first sidewall 36, and a second sidewall 38. The bottom wall 20 has both an inner surface 22 and an outer surface 24. The back wall 28 also has an inner surface 30, an outer surface 32, and a top edge 34.

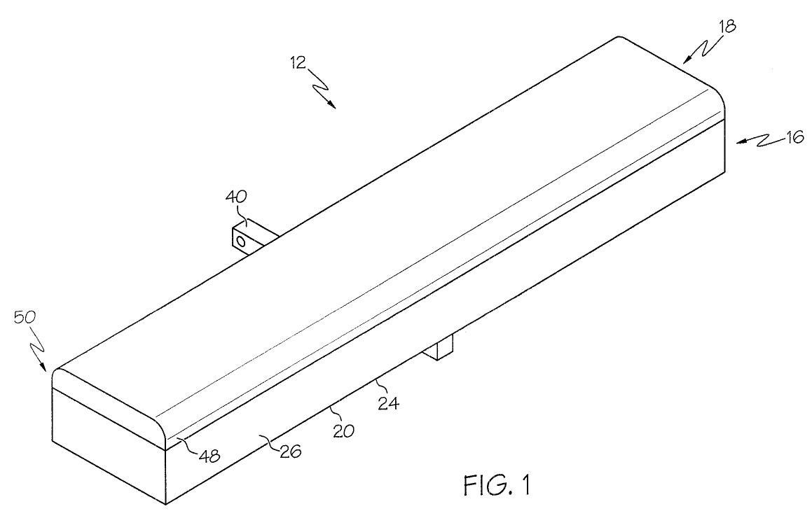

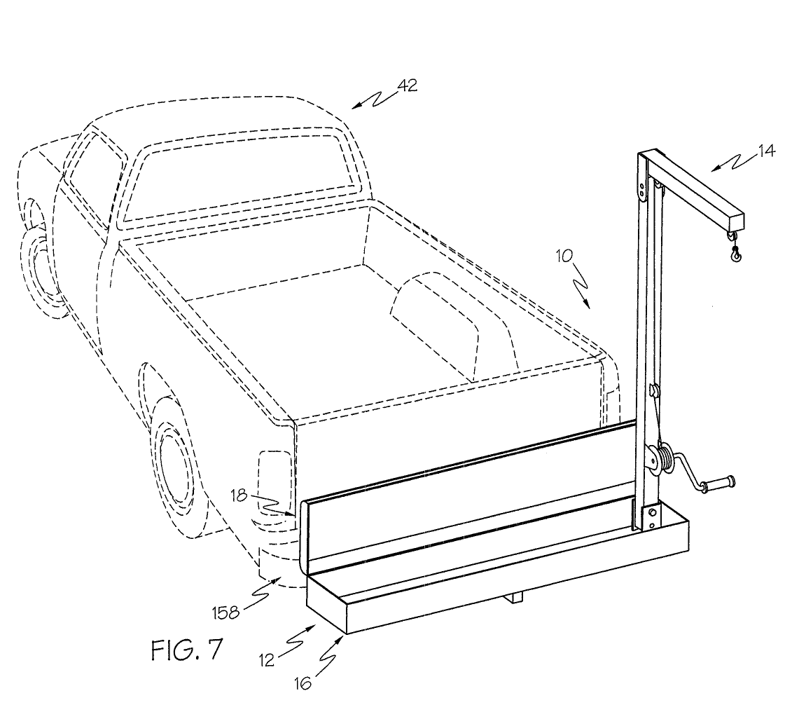

FIG. 1 shows one embodiment of the invention wherein a hitch connection member 40 is mounted to the outer surface 24 of the bottom wall 20. The hitch connection member 40 can then be slidably received in a hitch receiver (not shown) of a vehicle 42, as shown in FIG. 7.

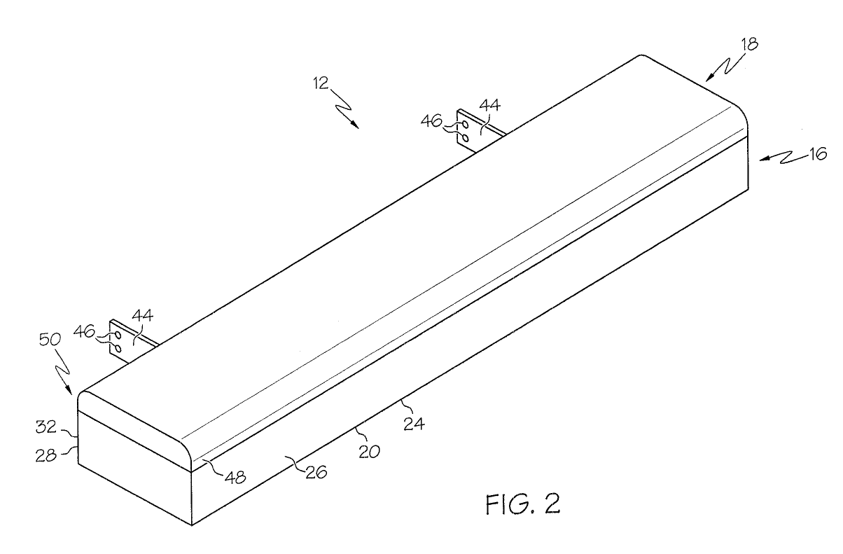

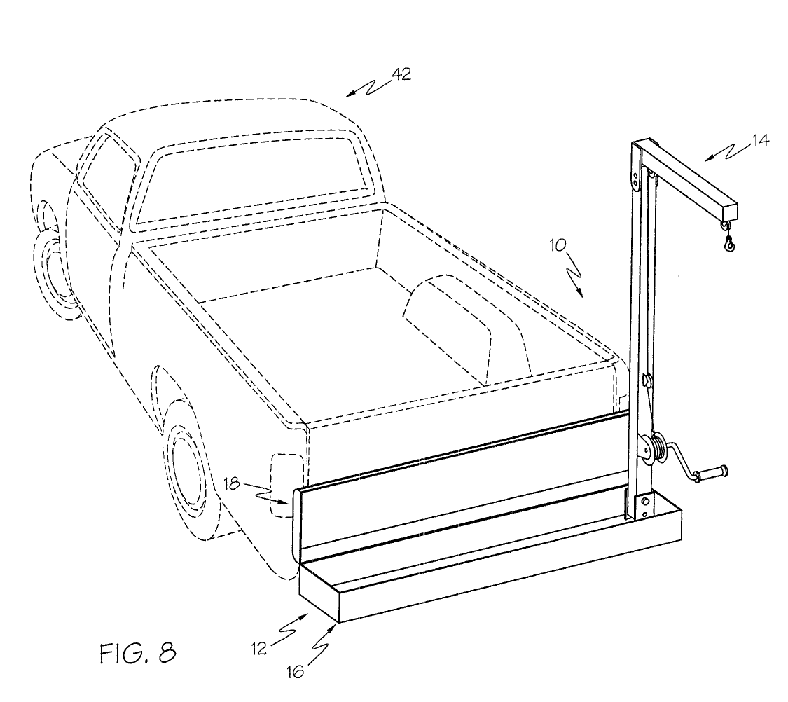

Turning to FIG. 2, another embodiment of the present invention is shown wherein mounting brackets 44 are secured the outer surface 32 of the base back wall 28. In another embodiment, the mounting brackets 44 are secured to the outer surface 24 of the base bottom storage receptacle 12 to the frame (not shown) of a vehicle 42 in lieu of a rear bumper 158. In the embodiment shown in FIG. 8, the storage receptacle 12 may replace the stock rear bumper of a vehicle 42.

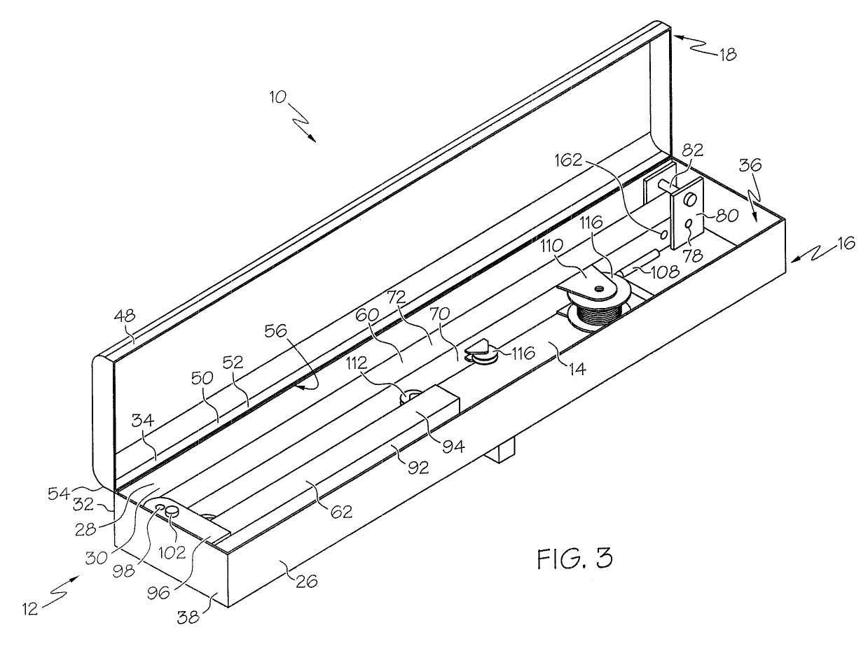

In FIG. 3, the lid 18 of storage receptacle 12 is shown in an open position and the game hanging apparatus 14 is shown in a collapsed or folded position. The lid 18 includes a front wall 48 and a back wall 50. The back wall 50 has an inner surface 52, an outer surface 54, and a bottom edge 56. In this embodiment, the lid 18 may be hingedly attached to the base 16.

At least one hinge (not shown) may be affixed to the inner surface 30 of the base back wall 28 proximate the top edge 34 and the inner surface 52 of the lid back wall 50 proximate the bottom edge 56. In an alternative embodiment, at least one hinge (not shown) is affixed to the outer surface 32 of the base back wall 28 proximate the top edge 34 and the outer surface 54 of the lid back wall 50 proximate the bottom edge 56. It will be appreciated by one skilled in the art that the lid 18 can alternatively be hingedly attached to the front wall 26, first sidewall 36, or second sidewall 38 of the base 16. In other embodiments, the lid 18 can be secured to the base 16 by other securement means such as latches, shock cord tie downs, dowels, and cotter pins.

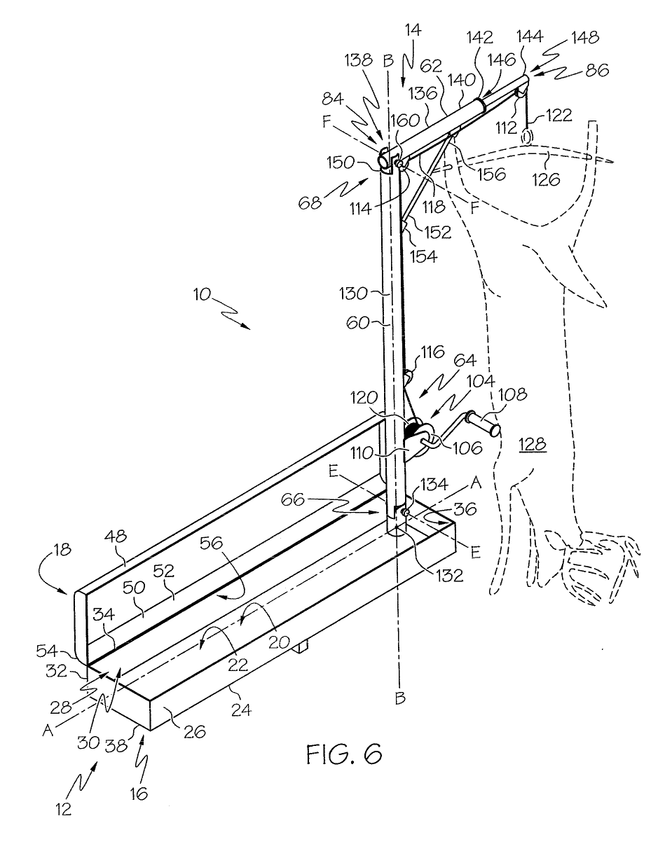

FIG. 4 shows the game hanging apparatus 14 in an unfolded, upright position. The game hanging apparatus 14 includes a mast 60, a boom 62, and a game suspension assembly 64. The mast 60 may be generally elongated and may be any suitable for use in the present invention. As shown in FIGS. 3-5 and 7-8, the mast is generally rectangular and, as shown in FIG. 6, the mast is generally cylindrical in shape. The mast 60 includes a first end 66 and a second end 68. The embodiment of the mast 60 shown in FIGS. 3-5 and 7-8 also has a first sidewall 70, a second sidewall 72, a third sidewall 74, and a fourth sidewall 76. Located proximate the mast first end 66 and on an axis C-C is a mast pivot point 78. The mast 60 is pivotally coupled to a mast bracket 80. The mast bracket 80, is in turn, affixed to the storage receptacle base 16. In the embodiment shown in FIGS. 3-5 and 7-8, the mast bracket 80 is affixed to the base bottom wall 20 and the base first sidewall 36.

A mast locking pin 82 is provided to secure the mast 60 in place when the mast 60 is in an unfolded, upright position, as shown in FIG. 4. The locking pin 82 protrudes through a mast first locking hole 162, as shown in FIG. 3, and a mast bracket locking hole (not shown) when being used to secure the mast 60 is in an unfolded, upright position.

The boom 62 includes a first end 84 and a second end 86. The boom 62 also has a first sidewall 88, a second sidewall 90, a third sidewall 92, and a fourth sidewall 94. Through a bracket 96 affixed to the boom first end 84, the boom 62 is pivotally coupled to the mast second end 68. The boom 62 pivots relative to the mast second end 68 about a pivot point 98 that is located on axis D-D.

A boom locking pin 102, as shown in FIG. 3, may be provided to secure the boom 62 in place when the boom 62 is in an unfolded, substantially horizontal position. The boom locking pin 102 protrudes through a boom bracket locking hole 100 and a mast second locking hole (not shown) when being used to secure the boom 62 is in an unfolded, substantially horizontal position.

The game hanging apparatus 14 of the present invention also includes a game suspension assembly 64. The game suspension assembly 64 includes a winch assembly 104, a cable 118, and at least one pulley 112. The winch assembly 104 includes a spool 106 and a handle 108 and is affixed to the mast 60 proximate its first end 66 with a bracket 110.

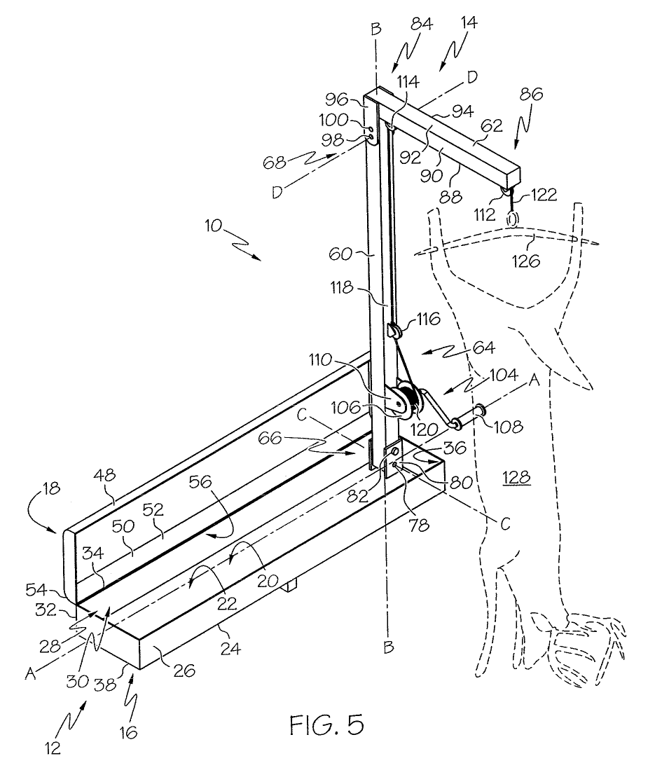

The cable 118 has a first end 120 and a second end 122. The cable first end 120 is coilingly engaged around the winch spool 106. The cable second end 122 is suspended from a pulley 112. Pulley 112 can be mounted to the boom first sidewall 88 proximate the boom second end 86. A hook 124 may be secured to the cable second end 122. A game gambrel 126 can be attached to the hook 124. In another embodiment, the game gambrel 126 may be directly secured to the hook 124. As shown in FIG. 5, an animal carcass 128 is hung directly from the game gambrel 126. It will be appreciated by one skilled in the art that the cable 118 can be replaced with rope, wire, cord, line, or any other flexible material suitable for use in the present invention.

The embodiment shown in FIGS. 3-5 includes two additional pulleys 114, 116 to guide the cable 118. In this embodiment, a pulley 114 is mounted to the boom first sidewall 88 proximate the boom first end 86. Another pulley 116 is mounted to the mast first sidewall 70 between the mast first end 66 and second end 68.

When the game hanging assembly 10 is not in use, it may be collapsed and stored in the storage receptacle 12. As discussed herein, the mast 60 is pivotally coupled to the mast bracket 80 which, in turn, is affixed to the storage receptacle base 16 to facilitate rotation of the mast 60 in a vertical plane parallel to the longitudinal axis A-A of the base 16. To lower the mast 60, a user first disengages the mast locking pin 82. Once the pin 82 is disengaged, the mast is rotated downwardly toward the storage receptacle 12.

Either prior to, subsequent to, or during the lowering of the mast 60, the user disengages the boom locking pin 102. Once the boom locking pin 102 is disengaged, the boom 62 is rotated toward the mast first sidewall 70. The boom 62 is pivotally coupled to the mast second end 68 on an axis D-D that is perpendicular to the longitudinal axis B-B of the mast 60 to facilitate rotation of the boom 62 in a plane parallel to the longitudinal axis B-B of the mast 60.

As shown in FIG. 3, once the mast 60 and boom 62 are folded and collapsed, the game hanging apparatus 14 fits within the storage receptacle 12. After the game hanging apparatus 14 is enclosed within the storage receptacle 12, the lid 18 can be closed. The game hanging apparatus 14 can then be transported and stored in the storage receptacle 12 until the user wishes to employ it again.

FIG. 6 shows another embodiment of the invention. In this embodiment, the mast 60 includes a cylindrical sidewall 130, a first end 66, and a second end 68. The mast first end 66 is pivotally coupled to a mast base 132 about a pivot point 134 that is located on an axis E-E. The mast base 132 is, in turn, affixed to the storage receptacle base 16. Once the mast 60 is in an upright position, the user engages a means (not shown) for locking the mast 60 in that position. It will be appreciated by one skilled in the art that a pin (not shown) located proximate the pivot point can serve as the means for locking the mast 60 in an upright position.

The embodiment shown in FIG. 6 has a boom 62 that includes an outer sleeve 136 and an inner rod 144 telescopically received therein. The boom outer sleeve 136 has a first end 138 and a second end 140. The boom inner rod 144 also has a first end 146 and a second end 148. The boom outer sleeve 136 and boom inner rod 144 may also be telescopically received within the mast second end 68. After the boom outer sleeve 136 is fully extended out of the mast second end 68, the boom outer rod first end 138 is pivotally coupled with a pin 160 to the mast second end 68 about a pivot point 150 that is located on an axis F-F. Once the boom inner rod 144 is fully extended, the user engages a pin (not shown) through a hole (not shown) proximate the outer sleeve second end 140 and a hole (not shown) proximate the inner rod end 146 for locking the boom inner rod 144 in its extended position.

The embodiment shown in FIG. 6 also includes a support rod 152. The support rod 152 locks the boom 62 in a substantially horizontal position. The support rod 152 includes a first end 154 removably attached proximate mast second end 68 and a second end 156 removably attached between boom outer sleeve first end 138 and boom outer sleeve second end 140.

The embodiment shown in FIG. 6 also has a game suspension assembly 64 that includes a winch assembly 104, a cable 118, and at least one pulley 112. The winch assembly 104 includes a spool 106 and a handle 108 and is affixed to the mast 60 proximate its first end 66 with a bracket 110. The cable 118 has a first end 120 and a second end 122. The cable first end 120 is coilingly engaged around the winch spool 106. The cable second end 122 is suspended from a pulley 112. Pulley 112 can be mounted proximate boom rod second end 148. A game gambrel 126 can be secured to the cable second end 122. As shown in FIG. 6, an animal carcass 128 is hung directly from the game gambrel 126. It will be appreciated by one skilled in the art that the cable 118 can be replaced with rope, wire, cord, line, or any other flexible material suitable for use in the present invention.

The embodiment shown in FIG. 6 includes two additional pulleys 114, 116 to guide the cable 118. In this embodiment, a pulley 114 can mounted proximate the boom outer sleeve first end 138. This pulley 114 can be removably mounted to allow boom outer sleeve 136 to be telescopically received by the mast second end 68. Another pulley 116 can be mounted to the mast cylindrical sidewall 130 between the mast first end 66 and second end 68.

When the game hanging apparatus 14 shown in FIG. 6 is not in use, it may be collapsed and stored in the storage receptacle 12. As discussed herein, the mast 60 is pivotally coupled to a mast base 132 which, in turn, is affixed to the storage receptacle base 16 to facilitate rotation of the mast 60 in a vertical plane parallel to the longitudinal axis A-A of the base 16. To lower the mast 60, a user first disengages the mast locking means (not shown). Once the mast locking means (not shown) is disengaged, the mast is rotated downwardly toward the storage receptacle 12.

Either prior to, subsequent to, or during the lowering of the mast 60, the user disengages the locking pin (not shown) that retains the boom inner rod 144 in its extended position. Once the lock pin (not shown) is disengaged, the inner rod 144 can be telescopically retracted into the outer sleeve 136.

Either prior to, subsequent to, or during the retracting of the inner rod 144, the user removes the support rod 152 from the mast second end 68 and the boom outer sleeve 136. Once the support rod 152 is removed, the user disengages the boom pin 160. After the boom pin 160 is disengaged, the outer sleeve 136 can be telescopically retracted into the mast second end 68 for storage. The embodiment shown in FIG. 6 includes a boom outer sleeve ring 142. Ring 142 is affixed proximate the outer sleeve second end 140 and has an outer diameter greater than the inner diameter of the mast 60. The ring 142 limits the telescopic movement of the boom outer sleeve 136 within the mast 60.

From the foregoing, it may be seen that the collapsible game hanger and storage device of the present invention is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. A vehicle-mounted collapsible game hanging assembly comprising:
a storage receptacle including a base and a lid; and
a game hanging apparatus including a mast, a boom, and a game suspension assembly;
wherein said mast includes a first end pivotally coupled to said base and a mast second end; and
wherein said boom includes a first end pivotally coupled to said mast second end and a boom second end.

2. The assembly of claim 1, said storage receptable further compromising a hitch connection member insertable into a vehicle hitch receiver.

3. The assembly of claim 1, said storage receptacle further comprising at least one mounting bracket for securing said storage receptacle to a vehicle frame.

4. The assembly of claim 3 wherein said storage receptacle is interchangeable with a vehicle rear bumper.

5. The assembly of claim 1 wherein said lid is hingedly attached to said base.

6. The assembly of claim 1, said game suspension assembly further comprising a winch assembly, a cable, and at least one pulley.

7. The assembly of claim 6 wherein said winch assembly is secured to said mast proximate said mast first end.

8. The assembly of claim 6, said game suspension assembly further comprising a first pulley secured to said boom proximate said boom first end, and a second pulley secured to said boom proximate said boom second end.

9. The assembly of claim 1 wherein said mast is pivotally coupled to said base to facilitate rotation of said mast in a vertical plane parallel to the longitudinal axis of said base.

10. The assembly of claim 1 further comprising a means for locking said mast in a substantially vertical position.

11. The assembly of claim 9 wherein said boom is pivotally coupled to said mast second end on an axis perpendicular to the longitudinal axis of said mast to facilitate rotation of said boom in a plane parallel to the longitudinal axis of said mast.

12. The assembly of claim 1, further comprising a means for locking said boom in a substantially horizontal position.

13. The assembly of claim 1 wherein said boom telescopically extends from said mast second end.

14. The assembly of claim 13, said boom further comprising an outer sleeve, an outer sleeve ring, and an inner rod wherein said outer sleeve includes a first end proximate to said boom first end and a second end, and said inner rod includes a first end and a second end proximate to said boom second end.

15. The assembly of claim 14 wherein said boom inner rod telescopically extends from second end of said boom outer sleeve.

16. The assembly of claim 14 wherein said boom outer sleeve ring is secured to said boom outer sleeve second end and has a diameter greater than a diameter of said mast for limiting telescopic movement of said boom therein.

17. The assembly of claim 15, further comprising a means for locking said boom in a telescopically extended position.

18. The assembly of claim 14, said game suspension assembly further comprising a first pulley secured to said boom proximate said boom outer sleeve first end, and a second pulley secured to said boom proximate said boom inner rod second end.

19. A vehicle-mounted collapsible game hanging assembly comprising:
a storage receptacle including a base and a lid; and
a game hanging apparatus including a mast, a boom, and a game suspension assembly;
wherein said mast includes a first end pivotally coupled to said base to facilitate rotation of said mast in a vertical plane parallel to the longitudinal axis of said base and a second end;
wherein said boom includes a first end pivotally coupled to said mast second end on an axis perpendicular to the longitudinal axis of said mast to facilitate rotation of said boom in a plane parallel to the longitudinal axis of said mast and a boom second end; and
wherein said game suspension assembly further comprises a winch assembly, a cable, and at least one pulley.

20. A game hanging assembly comprise:
means for raising game from the ground;
means for suspending game from said game hanging assembly;
means for attaching said game hanging assembly to a vehicle; and
means for collapsing said game hanging assembly into a configuration enabling said game hanging assembly to remain attached to said vehicle for transportation and storage.
